(19) United States
(12) Patent Application Publication
(10) Pub. No.: US 2012/0037295 A1
(43) Pub. Date: Feb. 16, 2012

(54) SHEET MATERIAL WITH INDEX OPENINGS AND METHOD FOR MAKING AND USING

(75) Inventors: Arthur J. Paulson, Minneapolis, MN (US); David J. Alvig, Richfield, MN (US); Matthew D. PeKarna, Chanhassen, MN (US)

(73) Assignee: DATACARD CORPORATION, Minnetonka, MN (US)

(21) Appl. No.: 13/279,728

(22) Filed: Oct. 24, 2011

Related U.S. Application Data
(62) Division of application No. 11/051,125, filed on Feb. 4, 2005, now abandoned.

(51) Int. Cl. B32B 37/00; B32B 38/10

(52) U.S. Cl. 156/64; 156/248

(57) ABSTRACT

A sheet material with index openings for use with a card printer. The sheet material comprises a substrate layer and registered elements that alternate with the index openings. The registered elements can be, for example, card-sized patches of laminating material or holograms. The index openings are used to achieve proper alignment of the registered elements to the cards.

### FIELD OF THE INVENTION

The invention relates generally to sheet materials for use in printing and processing cards. More specifically, the invention relates to sheet materials with registered elements used to cover or protect a card, to print information to a card, or to add a feature to a card such as a hologram.

### BACKGROUND OF THE INVENTION

Cards are used in a large number of applications, such as identification cards, security badges, employee badges, licenses, credit cards, and membership cards. These cards are often carried with a person continuously, so that they must be durable, resistant to breaking, and resistant to abrasion. In addition, these cards typically contain personal or unique information or images that are printed or recorded on the card and that must not degrade over time. Card printers are used to perform any of a number of processing steps to cards, including such steps as printing unique or custom information onto a card and applying a protective layer to the card. Card printers may be stand-alone devices, or may comprise multiple separate modules that operate together. Card printers may also be referred to as card processors.

A card printer may use any of a number of types of sheet materials in the course of processing a card. These various card processing sheet materials are typically supplied in the form of a strip of thin, flexible material wound onto a roll, and typically have a length that is much longer than their width. Certain card processing sheet materials may have registered elements. A registered element is a feature or part that must be accurately positioned relative to the card.

For example, it may be desired to protect the surface of a card by lamination. One way in which a card may be laminated is by applying a patch of laminating material onto the card surface. The lamination material is typically provided to a card printer on a sheet of substrate material with a plurality of lamination patches spaced thereon, where each lamination patch is pre-cut to be slightly smaller in size than the card that is to be laminated. For the lamination patch to be properly applied, the card and the patch element must be registered in the card printer so that they are accurately aligned prior to the lamination patch being applied to the card. The size of the patch allows for slight inaccuracies in positioning the patch relative to the card, so that the patch covers the card surface without the patch extending over any of the card edges. However, it is desired to have as much of the card surface laminated as possible. Inaccuracy in registering the lamination patch to the card may reduce the amount of the card surface that is laminated.

In addition, a card may contain a hologram that is used to verify the authenticity of the card and to make counterfeiting the card more difficult. The hologram may be applied to the card by transferring a hologram from a substrate of sheet material. The position of the hologram may need to be registered relative to the card so that the hologram is accurately positioned at the desired location on the card. If the hologram is not positioned accurately, it may, for example, obscure other information on the card.

Similarly, a card printer may be used to apply a registered topcoat to a card after the card is printed. The topcoat protects the surfaces of the card. A topcoat sheet may contain images or features, such as a hologram, that need to be accurately positioned on a card.

Further, a card printer may utilize an ink ribbon for printing information to a card. The ink ribbon may constitute a sheet of substrate material with alternating ink patches of various colors to allow a full color image to be printed to the card from a single ribbon. The location of the ink patches may need to be registered relative to the card to allow for accurate color printing.

To provide the correct position of registered sheet materials relative to cards, sheet materials have typically used printed index marks on the sheet. The index marks are sensed by a suitable sensing mechanism, and the sheet is advanced a certain distance once a mark is sensed, thereby placing the sheet material in proper position relative to the card. An example of the use of printed index marks on a sheet material is disclosed in U.S. Pat. No. 6,263,796.

While the use of printed index marks has proved generally adequate, further improvements in the positioning of sheet materials are desirable.

### SUMMARY OF THE INVENTION

The invention relates to registered sheet materials used in processing a substrate, and a method of utilizing registered sheet materials in processing a card. The substrates are preferably plastic cards, for example identification cards, security badges, employee badges, driver's licenses, credit cards, membership cards, etc. The sheet materials are any registered sheet material that is used in the processing of a card, for example a sheet containing lamination patches or holograms.

The sheet material is configured to enable the sheet material to be positioned accurately relative to a card or other item to be processed. Preferably, the sheet material is provided with index openings which are used to provide the proper positioning of the sheet materials relative to the card.

In one aspect of the invention, the sheet material comprises a strip of substrate material having a plurality of index openings formed in the substrate material at spaced locations along the length thereof. A plurality of registered elements, such as lamination patches, are disposed on the substrate material at spaced locations along the length thereof. The strip of substrate material can be wound onto a core as part of a supply of the material.

A method of using a sheet material comprises a light-emitting source that directs light toward the sheet material and a light sensor that detects the reflection of the light from the sheet material. The light-emitting source and light sensor are configured so that the presence of an index opening can be determined and a corresponding signal may be communicated to a control system of the card printer.

A method of manufacturing a sheet material comprises adhering a lamination material to a substrate material, ladder cutting the lamination material without cutting the substrate material, removing the ladder cut lamination material thereby leaving behind a plurality of lamination patches on the substrate material, and punching index openings through the lamination material so that the index openings are spaced from the lamination patches.

### BRIEF DESCRIPTION OF THE DRAWINGS

FIG. 1 is a top view of a preferred embodiment of a card processing sheet material with index openings for laminating patches to a card.

FIG. 2 is a schematic view of a portion of a laminating mechanism that utilizes the sheet material of FIG. 1.

FIG. 3 illustrates a sheet material with multiple index openings.

FIG. 4A-B illustrates steps in the formation of the sheet material.

FIG. 5 illustrates a sensing mechanism used to sense the location of an index opening in a sheet material.

### DETAILED DESCRIPTION OF THE PREFERRED EMBODIMENT

The invention relates to registered sheet materials used in processing a substrate, such as a card, a method of utilizing registered sheet materials in processing a substrate, and a method of manufacturing a registered sheet material used in processing a substrate. The sheet material is configured to enable a substrate (i.e., a card) to be positioned accurately relative to the sheet material. The sheet material may be used in a card processor, such as that disclosed in U.S. patent application entitled “Desktop Card Processor,” attorney docket number 02968.0262US01, filed Feb. 4, 2005.

The substrates will be described herein as being plastic cards, for example identification cards, security badges, employee badges, driver's licenses, credit cards, membership cards, etc. However, the invention could be used with other substrates as well.

The sheet material is any long, thin material that is consumed during the processing of substrates, including cards, and that must be positioned accurately with respect to the substrate. For example, sheet materials may include lamination material, holograms, topcoats, or ink ribbons.

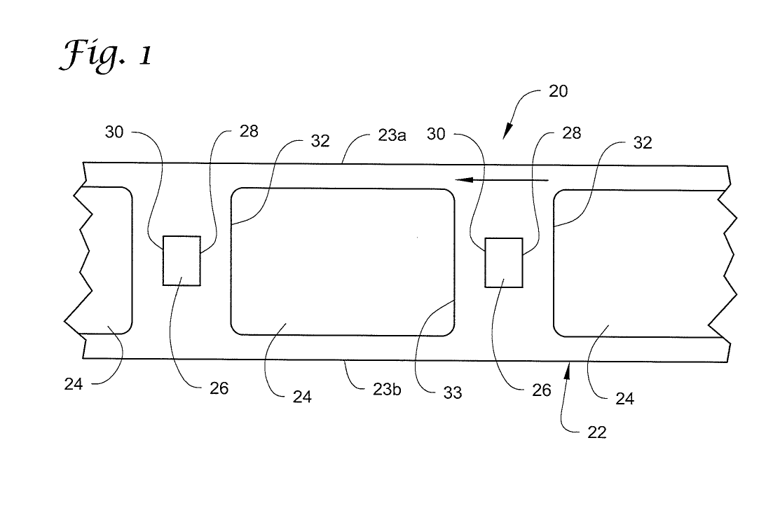

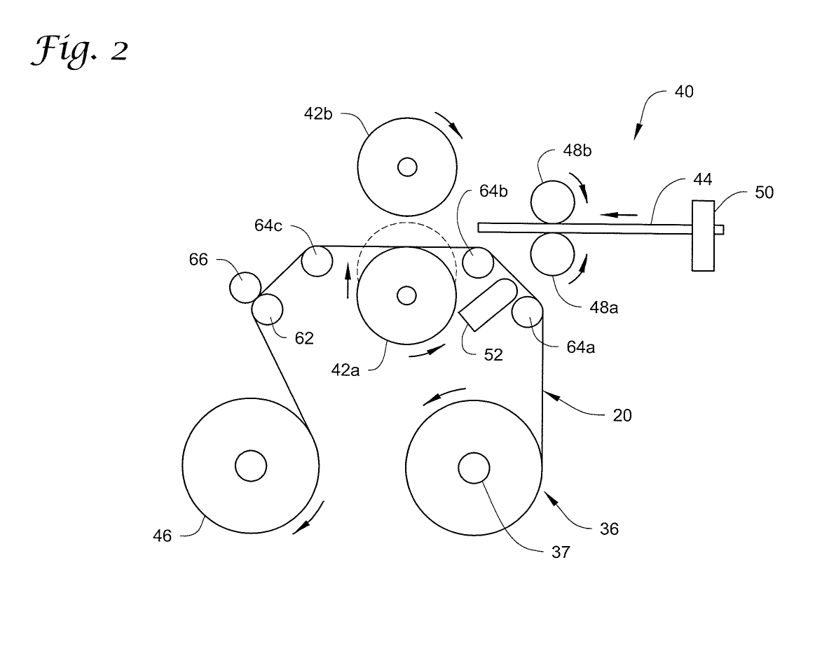

Attention is now directed to the figures. FIG. 1 illustrates a portion of sheet material 20 in accordance with a preferred embodiment of the present invention, for use in a card processor. In particular, FIG. 1 represents a sheet material for laminating patches to a card. The sheet material 20 comprises a strip of substrate material 22 having first and second edges 23a, 23b. As shown in FIG. 2, the sheet material 20 will typically be provided as a length of material on a supply roll 36, with the sheet material 20 wound onto a supply core 37.

The sheet material 20 includes a plurality of laminating patches 24 provided on the substrate 22 at spaced locations along the length thereof, and a plurality of index openings 26 formed in the substrate 22 at spaced locations along the length thereof. The card printer may be configured so that sheet material 20 moves in the direction indicated by the arrow in FIG. 1. In this manner, lamination patch 24 may be said to have a leading edge 32 and a trailing edge 33. Similarly, index opening 26 has a leading edge 30 and a trailing edge 28. As shown in FIG. 1, the index openings 26 and the lamination patches 24 repeat in alternating order, with an index opening 26 formed downstream of the associated lamination patch 24, in the direction of the intended movement of the sheet material 20. Alternatively, an index opening 26 may be formed upstream of the associated lamination patch 24, in the direction of the intended movement of the sheet material 20.

The lamination patches 24 are configured and sized to cover the substantial entirety of a card surface when laminated thereto. For example, if the card is a standard ID-1 card, which has a length of approximately 3.370 inches and a height of approximately 2.125 inches, each patch is slightly less than 3.370 inches by 2.125 inches. The size of each patch 24 is slightly less than the size of the card surface to account for slight inaccuracies in positioning the card and patch.

The material used to form patch 24 should resist wear and abrasion, and should also be sufficiently transparent to allow the underlying information present on the card to be accessed, either visually or by electronic means. An example of a suitable material for the patches 24 is polyethylene terephthalate (PET).

There is at least one index opening 26 associated with each registered element, such as lamination patch 24. The index openings 26 are sensed by a sensing mechanism, described below, as part of the process of achieving alignment of the patch with a card. In the illustrated embodiment, the index openings 26 are positioned approximately midway between successive patches 24 and between the edges 23a, 23b of the substrate 22. However, the index openings may be positioned at other locations on the substrate 22.

The index openings 26 shown in FIG. 1 are generally rectangular holes that are cut through the substrate 22. Both the leading edge 30 and the trailing edge 28 are preferably straight and parallel to the leading edge 32 of each laminating patch 24. However, index openings 26 having other shapes may be used. A suitable size for the index openings 26 is about ¼ of an inch wide (from leading edge 30 to trailing edge 28) and about ⅜ of an inch tall. However, index openings 26 having other sizes may be used.

Substrate 22 is formed of a material that is at least partially reflective, such that at least a portion of light incident upon a surface of substrate 22 is reflected. Alternatively, substrate 22 may be formed of a material that is at least partially opaque, such that at least a portion of light incident upon a surface of the substrate 22 is not transmitted through the substrate 22. An example of a suitable substrate material is polyethylene terephthalate (PET). The substrate 22 is preferably about two and ⅝ inches wide as measured between the side edges 23a, 23b and about 1.5 mils (about 0.0015 inches) thick. The substrate 22 may also contain an adhesive on one surface to help secure the lamination patches 24 to the substrate 22.

FIG. 2 shows schematically how the sheet material 20 is used within a lamination mechanism 40. The lamination mechanism 40 can form a portion of a card printer, or other card processing equipment, that performs printing operations on cards prior to the cards being laminated. Alternatively, the lamination mechanism can be separate from the card printer or other card processing equipment.

The lamination mechanism 40 comprises a pair of rollers 42a, 42b that are rotatable about their central axes. Preferably, the roller 42b is rotatably driven through a suitable connection to a DC stepper motor (not shown). A servomotor could also be used. The roller 42a is driven in the opposite direction at the same speed as the roller 42b through frictional engagement with the roller 42a or the sheet material 20 or both. Preferably, the roller 42a is heated and the roller 42b is unheated, and the roller 42a is further mounted so as to be moveable towards and away from the roller 42b between a first position, in which the roller 42a is disposed adjacent the roller 42b (shown in dashed lines in FIG. 2), and a second position, in which the roller 42a is spaced from the roller 42b (shown in solid lines in FIG. 2). The roller 42a is preferably driven to the first position by a gearmotor (not shown). In the first position of the roller 42a, a roller nip is formed between the rollers 42a, 42b with the sheet material 20 and a card 44 to be laminated passing through the roller nip, with the heated roller 42a pressing a patch 24 on the sheet material 20 into contact with one side of the card 44 and the roller 42b pressing against the other side of the card.

The sheet material 20 is supplied from the supply roll 36 and is guided through the lamination mechanism by idler rollers 64a, 64b, 64c. Capstan roller 62 is driven by a stepper motor (not shown) to advance sheet material 20 through the laminating mechanism. Idler roller 66 is driven through frictional engagement with capstan roller 62 or sheet material 20 or both. Consumed sheet material 20 is taken up onto a take-up roll 46. The take-up roll 46 is rotatable in the direction of the arrow in FIG. 2 by a suitable connection to a stepper motor (not shown), to thereby wind the consumed sheet material 20 to the take-up roll 46. The stepper motor is connected to take-up roll 46 through a slip clutch, to allow the take-up roll to maintain tension on the sheet material 20 without pulling the sheet material 20 through the nip created by capstan roller 62 and idler roller 66.

Further, a pair of drive rollers 48a, 48b are disposed upstream of the rollers 42a, 42b, with the card 44 extending between the drive rollers 48a, 48b such that the roller 48a engages one side of the card and the roller 48b engages the opposite side of the card. The rollers 48a, 48b are rotatable in opposite directions at the same speed. Rollers 48a, 48b are driven through a suitable gear train connection to roller 42b (not shown). Alternatively, rollers 48a, 48b may be driven through a suitable belt connection to roller 42b. The rollers 48a, 48b are used to drive the card 44 into the nip of the rollers 42a, 42b.

A registration photocell 50 is mounted upstream of the drive rollers 48a, 48b to detect the presence of the card 44, thereby providing an input to the control system of the lamination mechanism 40.

Further, an index opening sensing mechanism 52 is provided to sense each index opening 26 in sheet material 20, thereby providing another input to the control system of the lamination mechanism 40. The sensing mechanism 52 is preferably configured to sense the presence of each index opening and thereby provide input to the control system of the position of patch 24.

Referring to FIG. 5, the sensing mechanism 52 comprises a light emitting source 54 positioned adjacent the sheet material 20 that projects infrared light toward the sheet material 20, and a light sensor 56, such as a reflective photocell, that receives light from the light emitting source. The source 54 and sensor 56 are positioned so that light from the source 54 reflects off of the substrate material and travels to the sensor 56. Whenever substrate material is proximate to the source 54, the sensor 56 will register the reflection of light from the substrate. However, when an index opening is proximate to the source 54, the light will travel through the index opening instead of being reflected to the sensor 56. The difference in light intensity received by the sensor 56 when the index opening is present determines the presence of the index opening 26.

Alternatively, the light emitting source 54 may be positioned on one side of the sheet material 20 and the light sensor 56 may be positioned on the opposite side of the sheet material. In this embodiment, the source 54 and sensor 56 are positioned so that light from the source 54 can travel through the sheet material 20 and to the sensor 56. This embodiment requires that the substrate material be at least partially opaque. Whenever the substrate material is between the source 54 and the sensor 56, the amount of light striking light sensor 56 will be less than the amount of light emitted from light emitting source 54 because of the opacity of the substrate. However, when an index opening is between the source and sensor, light travels relatively unimpeded through the index opening to the sensor. The difference in light intensity received by the sensor 56 when the index opening is present determines the presence of the index opening.

In operation, sensing mechanism 52 looks for an index opening 26 in the sheet material 20. When an index opening is sensed, a signal is sent to the control system of the lamination mechanism 40. The control system then operates the drive rollers 48a, 48b, capstan roller 62, and take-up roll 46 so that the leading edge of the patch 24 is positioned at an optimal location between the drive rollers 48a, 48b. The control system then advances the card 44 so that the leading edge is also positioned at an optimal location between the drive rollers 48a, 48b. The roller 42a is then driven toward the roller 42b and the patch is laminated onto the card using known techniques. Further details on achieving registration between a card and a lamination patch are disclosed in U.S. Pat. No. 6,263,796 which is hereby incorporated by reference in its entirety.

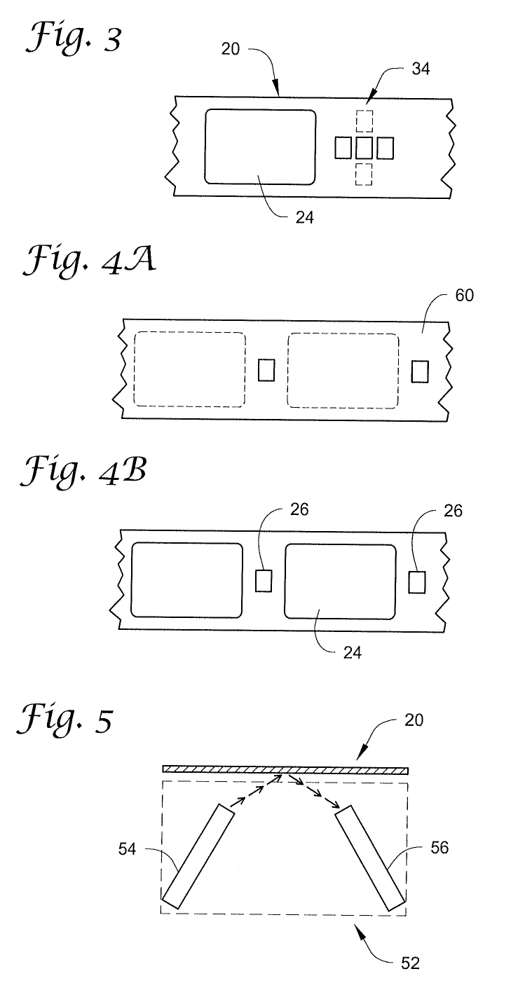

FIG. 3 illustrates the optional use of multiple index openings 34. These multiple index openings 34 may have any orientation on the sheet material, such as in-line with the length of the sheet material or transverse to the length of the sheet material. The sensing mechanism 52 may then be adapted to function appropriately according to the orientation of these multiple index openings 34. Alternatively, multiple index openings may be provided only at or near the end of sheet material 20. In this way, the sensing mechanism 52 may sense the succession of index openings 34 to recognize that the end of the sheet material 20 is approaching. Alternatively, the end of the sheet material 20 can be determined without the use of multiple index openings 34 by sensing whether the end of the sheet material has pulled away from the supply core 37.

With reference to FIG. 4A-4B, the sheet material 20 is manufactured by adhering together a sheet of the substrate material and a sheet of the lamination material to create a laminated sheet. The width of the laminated sheet is preferably several multiples (such as 4 to 5) of the width of strip 60, to allow multiple sheet materials 20 to be produced simultaneously. Alternatively, the laminated sheet could be a strip the same width as sheet material 20. The laminated sheet is then preferably cut with a single die cutting tool to form the edges 23a, 23b of a strip 60 and the index openings 26, and the laminated sheet is also ladder cut with the same die cutting tool to create the shape of the laminating patches 24 by cutting through only the laminating material and not through the substrate material. Alternatively, multiple die cutting tools may be used to form these features. The ladder cut lamination material outside of the patches is then pulled away from the substrate material for disposal, leaving a continuous strip of substrate material with a plurality of lamination patches as shown in FIG. 4B.

1-13. (canceled)

14. A method of manufacturing a sheet material for a card lamination mechanism, comprising:
adhering a lamination material to a substrate material;
ladder cutting the lamination material, without cutting the substrate material;
removing the ladder cut lamination material, leaving behind a plurality of lamination patches on the substrate material; and
creating index openings through the lamination substrate material so that the index openings are spaced from the resulting lamination patches.

15. The method of claim 14, further comprising slitting the lamination material and the substrate material into at least one strip.

16. The method of claim 14, wherein the ladder cutting and the creation of the index openings are performed by the same tool.

17. The method of claim 14, wherein the lamination material is ladder cut so that each lamination patch is configured and sized for lamination to a card surface.

18. The method of claim 14, wherein the index openings are created so that the index openings are formed in the substrate material between first and second edges thereof.

19. A method of using a sheet material in a card lamination mechanism for laminating a card, comprising:
loading a sheet material into the lamination mechanism, the sheet material including a strip of substrate material having a length and first and second edges, and a central longitudinal axis midway between the first and second edges; a plurality of rectangular transferable transparent elements that have the same size removably disposed on a first surface of the substrate material at spaced locations along the length thereof so that the elements are not directly connected to each other, each transferable element having a leading edge and a trailing edge; and a plurality of openings formed through the substrate material at spaced locations along the length thereof between the first and second edges; wherein each one of the openings is associated with a corresponding one of the rectangular transferable transparent elements, and for each pair of adjacent transferable elements there is at least one of the openings disposed between the leading edge of one transferable element and the trailing edge of the other transferable element so that the opening does not extend through the transferable elements, and the central longitudinal axis intersects the plurality of openings;
projecting light from a source of light against the substrate material;
receiving said projected light;
detecting the presence of one of the openings in the substrate material from the intensity of the light received;
providing a signal to a control system when the opening is detected to indicate the position of the rectangular transferable transparent element associated with the detected opening; and
after detecting the presence of the opening, registering the associated rectangular transferable transparent element with a surface of the card to be laminated and laminating the associated rectangular transferable transparent element to the surface of the card.

20. The method of claim 19, wherein said light from said source of light is projected toward a surface of said sheet material, said light being reflected from said sheet material and received on the same side of said sheet material.

21. The method of claim 19, wherein said light from said source of light is projected toward a surface of said sheet material, said light being at least partially absorbed by said sheet material and received on the opposite side of said sheet material.

22. The method of claim 19, comprising printing on the surface of the card prior to laminating the associated rectangular transferable transparent element to the surface of the card.

23. A method of laminating a plastic card, comprising:
loading a supply roll of sheet material into a lamination mechanism, the supply roll including a substrate having a length and first and second edges, and a central longitudinal axis midway between the first and second edges; a plurality of rectangular transferable lamination patches that have the same size removably disposed on a first surface of the substrate at spaced locations along the length thereof so that the lamination patches are not directly connected to each other, each of the lamination patches having a leading edge and a trailing edge; and a plurality of openings formed through the substrate at spaced locations along the length thereof between the first and second edges; wherein each one of the openings is associated with a corresponding one of the lamination patches, and for each pair of adjacent lamination patches there is at least one of the openings disposed between the leading edge of one lamination patch and the trailing edge of the other lamination patch so that the opening does not extend through the lamination patches, and the central longitudinal axis intersects the plurality of openings;
after loading, optically detecting the presence of one of the openings in the substrate by directing light from a light source toward the substrate, and providing a signal to a control system of the lamination mechanism to indicate the position of the lamination patch associated with the detected opening; and
after detecting the presence of the opening, registering the associated lamination patch with a surface of the plastic card to be laminated and laminating the associated lamination patch to the surface of the plastic card using the lamination mechanism.

24. The method of claim 23, wherein the light source is positioned on a first side of the substrate and the light from the light source is directed toward a surface of the substrate, and the light is reflected from the substrate and received by a sensor positioned on the first side of the substrate.

25. The method of claim 23, wherein the light source is positioned on a first side of the substrate and the light from the light source is directed toward a surface of the substrate, and the light is at least partially absorbed by the substrate and received by a sensor on a second side of the substrate.

26. The method of claim 23, comprising printing on the surface of the plastic card prior to laminating the associated lamination patch to the surface of the plastic card.
